(19) United States
(12) Patent Application Publication
(10) Pub. No.: US 2018/0295437 A1
(43) Pub. Date: Oct. 11, 2018

(54) ELECTRO-ACOUSTIC PRODUCT STABILIZING DEVICE

(71) Applicant: TECHWIN COMMUNICATIONS CO., LTD., Taoyuan City (TW)

(72) Inventor: Chung-Hsien CHEN, Taoyuan City (TW)

(21) Appl. No.: 15/484,150

(22) Filed: Apr. 11, 2017

(51) Int. Cl. H04R 1/10

(52) U.S. Cl. CPC H04R 1/105; H04R 1/1066; H04R 1/1041; H04R 1/1016

(57) ABSTRACT

An electro-acoustic product stabilizing device includes: a sound device; an angle adjustment element, coupled pivotally to one side of the sound device; a hard fixation portion, configured on one side of the angle adjustment element; and a flexible support element, in connection with the angle adjustment element. Whereby, when the electro-acoustic product of the present invention is a headset or hearing aid, it is attached and fixed in a user's ear through the characteristic of the flexible support element being capable of adaptable shape change to be fixed to the use's inner ear bones; and then, the attachment of the flexible support element to the ear to be more comfortable through the angle adjustment element in combination with the sound device. In addition, the strengthening fixation of the hard fixation portion to the sound device increases the combination stability of the sound device with the ear.

### (a) TECHNICAL FIELD OF THE INVENTION

The present invention relates to an electro-acoustic stabilizing device, and more particularly to an electro-acoustic stabilizing device, taking into account the comfort of a soft earplug and the stability of a hard ear hook, and capable of angle adjustment.

### (b) DESCRIPTION OF THE PRIOR ART

The quick development of wireless telecommunication brings modern people a convenient and quick communication way; indispensable communication equipment is receivers and transmitters; among these, headset type equipment conforms to modern life requirements because it can be used without hand-holding. The quality judgment of a headset takes not only the sound quality but the wearing comfort thereof into consideration, since the wearing comfort is also very important.

Everybody's auricle shape is different because of genetic factors. However, the ear hooks of conventional against-the-ear microphone are integrally molded plastic and generally made with the same mold such that their shapes are very fixed. In addition, the plastic ear hooks have no deformation capability; they cannot correspond to each user's ear shape to make the appropriate changes such that the ear hooks are easy to loose upon wearing, or the ear hooks are too tight and let users feel discomfort, and even worse, cause the users' ear skin inflammation.

In addition, the comfort requirements of ear canal type earphones are increased gradually because headsets are used more and more often such that the air hooks are changed to be soft plastic bodies, allowing them to be fixed on inner ear bones. However, although soft ear hooks are rather comfortable while fixed on inner ear bones, but soft material is obviously insufficient in fixation strength compared to plastic ear hooks, and cannot be suited really to all users because even if it is soft, there is still a slight difference in the contours of the inner ear of each person.

The air canal type earphone mentioned above have the following disadvantages in use:
1. earplug material has no deformation capability such that it cannot correspond to every user's ear shape.
2. the fixation strength of soft earplugs is insufficient, while hard earplugs cause skin inflammation easily.
3. soft colloid ear hooks are still limited in size, and cannot be replaced.

### SUMMARY OF THE INVENTION

The main object of the present invention is to provide an electro-acoustic product stabilizing device, integrating the comfort of soft combination with the stability of hard combination on inner ear bones.

Another object of the present invention is to provide an electro-acoustic product stabilizing device, allowing a sound device to be used more conveniently with an angle adjustment device.

To achieve the objects mentioned above, the present invention proposes an electro-acoustic product stabilizing device, including: a sound device; an angle adjustment element, coupled pivotally to one side of the sound device, and adapted to adjust an angle of the sound device; a hard fixation portion, configured on one side of the angle adjustment element; and a flexible support element, in connection with the angle adjustment element and configured on one side thereof away from the sound device, and capable of being adapted to a user's ear cartilage contours and deformed freely to perform fixation. Whereby, when the electro-acoustic product of the present invention is a headset or hearing aid, it is attached and fixed in a user's ear through the characteristic of the flexible support element being capable of adaptable shape change to be fixed to the use's inner ear bones; and then, the attachment of the flexible support element to the ear to be more comfortable through the angle adjustment element in combination with the sound device. In addition, the strengthening fixation of the hard fixation portion to the sound device increases the combination stability of the sound device with the ear. Therefore, the fixation and support with the hard and soft combinations increase the configuration stability of the sound device, and provide the function of angle change.

### BRIEF DESCRIPTION OF THE DRAWINGS

FIG. 1 is a perspective view of a preferred embodiment of the present invention;

FIG. 2 is an exploded view of the embodiment of the present invention;

FIG. 3 is an exploded view of the embodiment of the present invention viewing from another angle;

FIGS. 4 to 6 respectively are a schematically perspective view of the embodiment of the present invention upon operation; and

FIG. 7 is a perspective view of another preferred embodiment of the present invention.

### DETAILED DESCRIPTION OF THE PREFERRED EMBODIMENTS

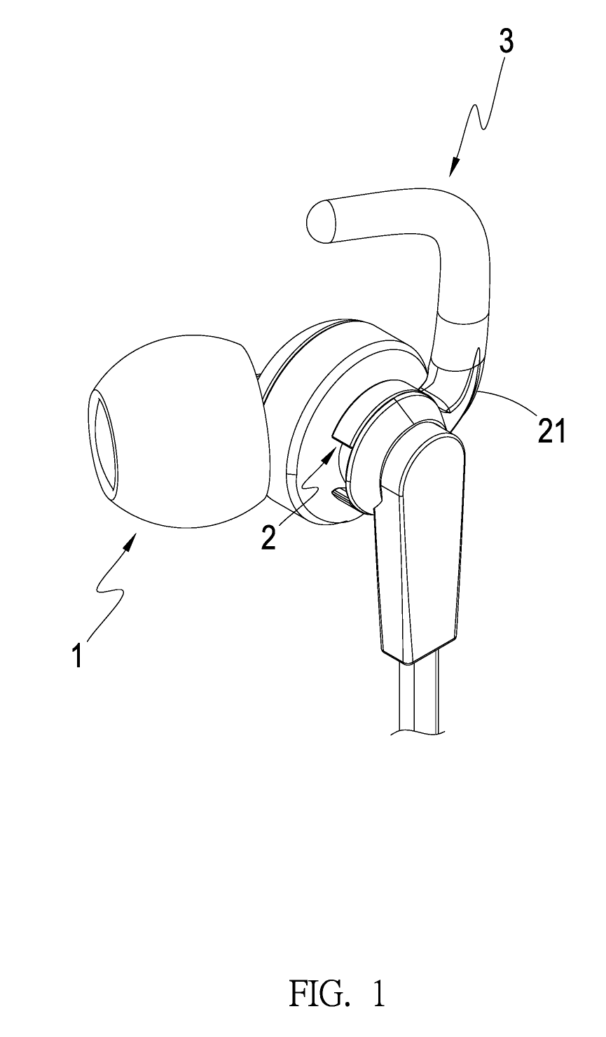

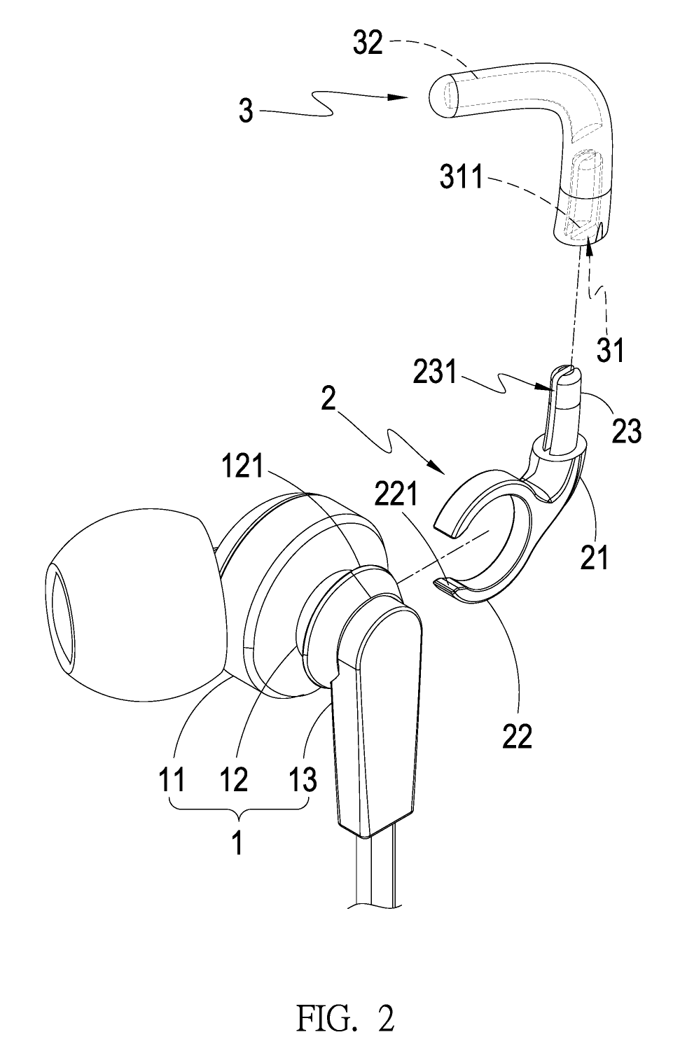

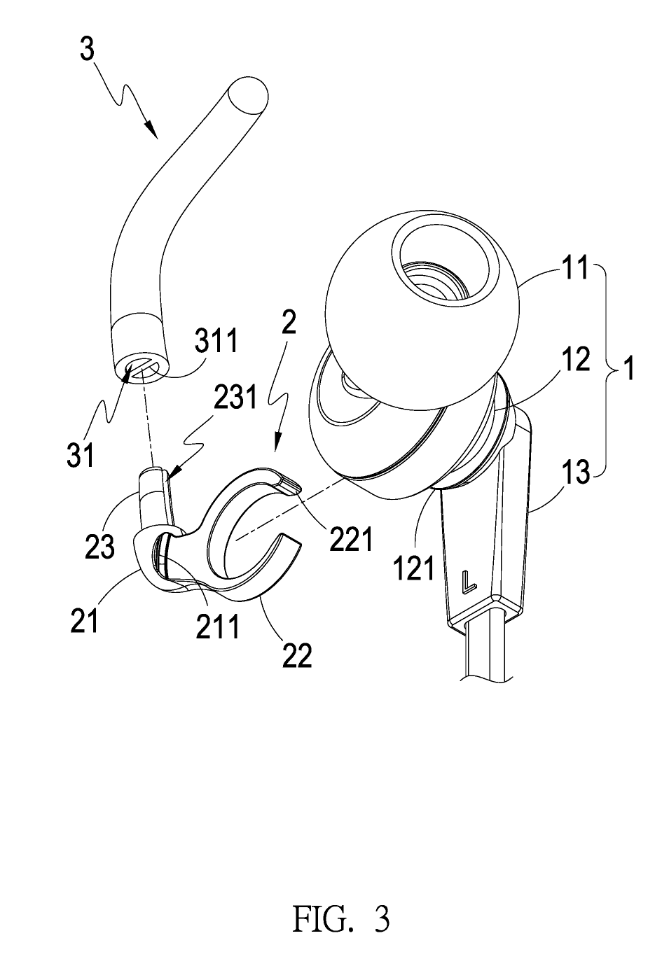

Referring to FIGS. 1 to 3, which respectively are a perspective view, exploded view and another exploded view of a preferred embodiment of the present invention, it can be clearly seem from the figures that an electro-acoustic product stabilizing device of the present invention includes: a sound device 1, including an earplug seat 11, connection piece 12 configured on one side of the earplug seat 11, and electronic device 13 configured on one side of the connection piece 12 far away from the earplug seat 11, with the connection piece 12 including a position limiting portion 121 adapted to avoid the sliding of a clamping portion 22 mentioned below; an angle adjusting element 2, coupled pivotally to one side of the sound device for the angle adjustment of the sound device, and including the clamping portion 22 clamped detachably to the connection piece 12, and at least one antiskid portion 221 configured on the inner side of the clamping portion 22; a hard fixation portion 21, configured on one side of the angle adjusting element 2, one side thereof formed with a positioning portion 211 adapted to fasten the outer edge of the earplug seat 11; at least one buckling portion 23, formed on one end of the hard fixation portion 21, and including at least one engagement slot 231; a flexible support element 3, in connection with one end of the angle adjustment element 2 and far away from the sound device 1, capable of being adapted to a user's ear cartilage contours to deform freely to perform fixation; at least one engagement portion 31, formed on one end of the flexible support element 3, and including at least one position limiting rib 311 in engagement with the engagement slot 231; and at least one hollow section 32, formed inside the flexible support element, and adapted to increase the deformation capability of the flexible support element 3.

The structure of the present invention can be understood clearly from the description mentioned above. The cooperation of the corresponding components of this structure achieves both the comfort of the soft earplug and the stability of the hard ear hook, and has free angle adjustment; the detailed will be described as the following:

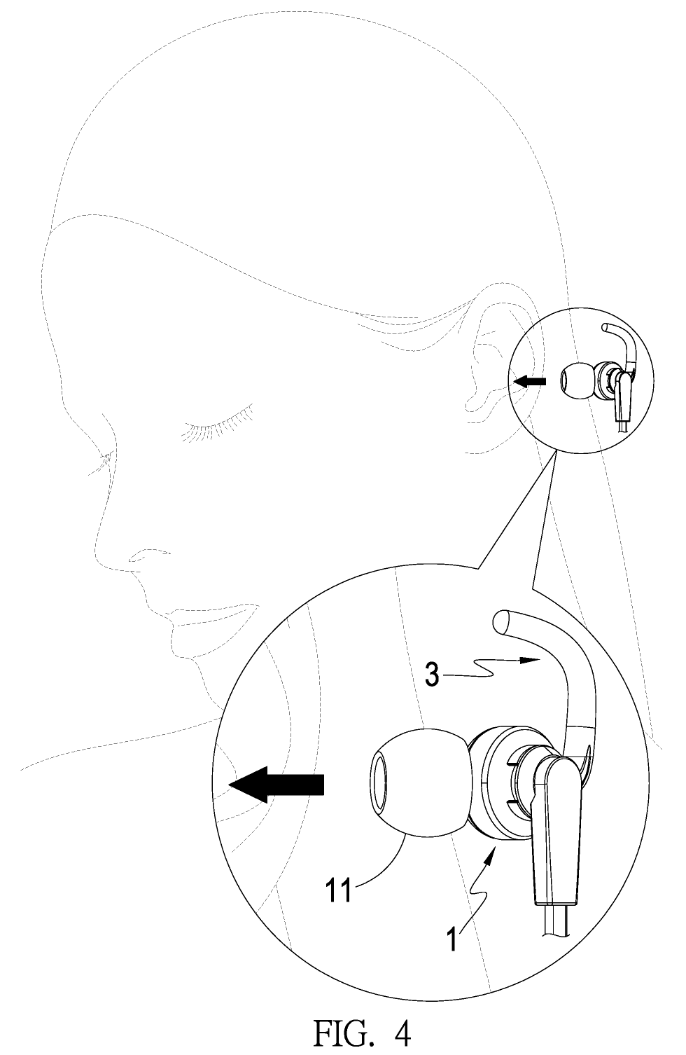

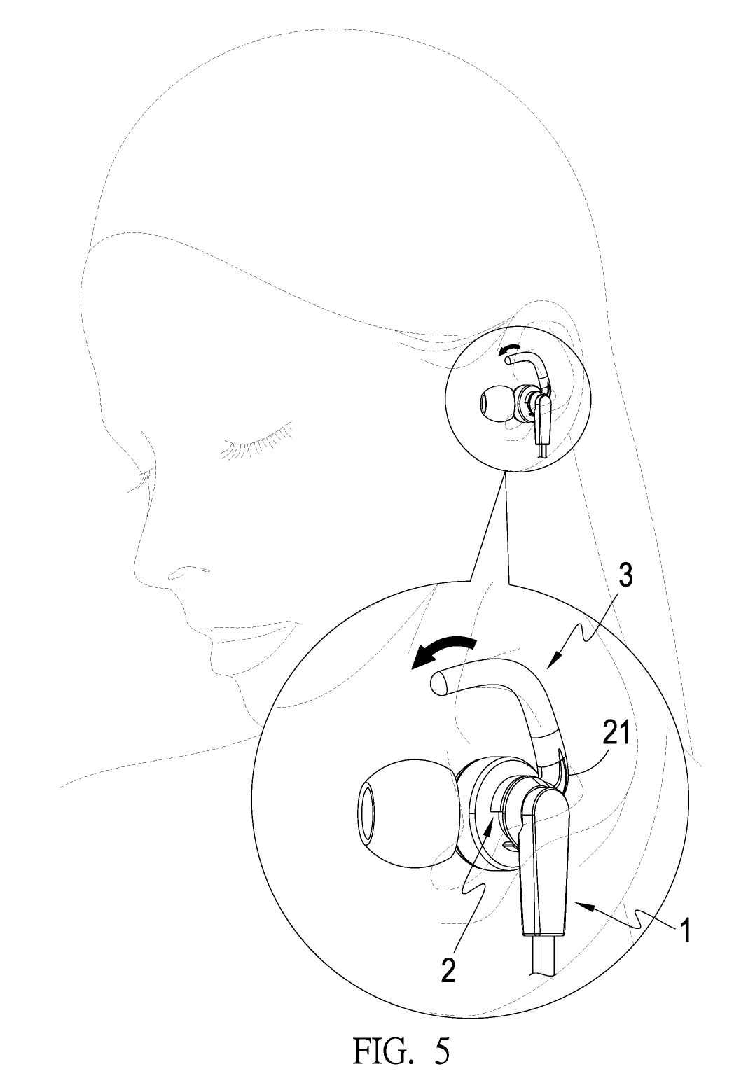

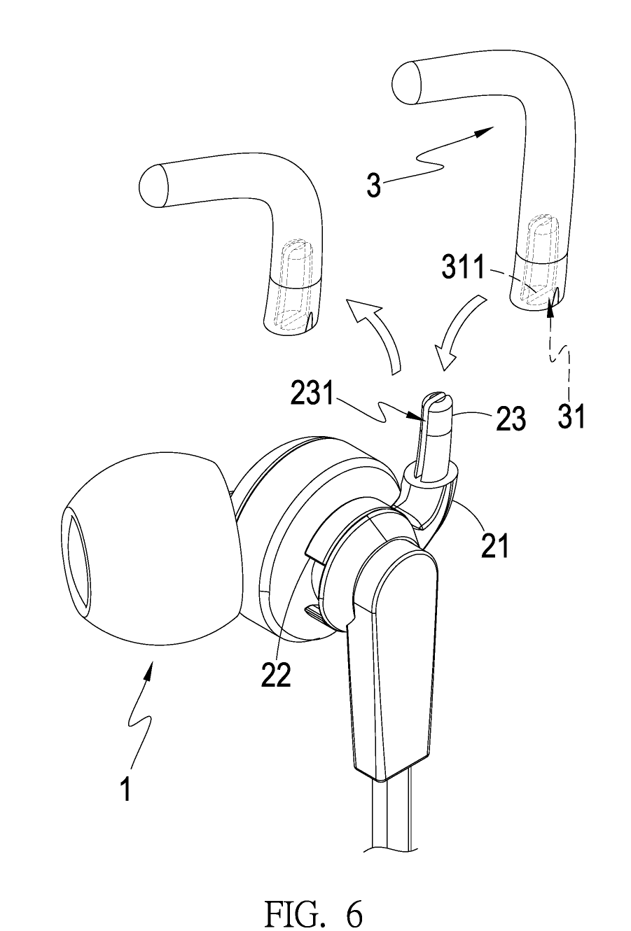

Referring to FIGS. 1 to 6, the sound device 1 includes the earplug seat 11 adapted to block an ear, the columnar connection piece 12 adapted to be in connection with the angle adjustment element 2, and the electronic device 13 on the another of the connection piece 12 is configured on one side of the earplug seat 11, where the electronic device 13 is a microphone if the sound device 1 is a headset, a radio and loudspeaker device if the sound device is a hearing aid, and a radio and translation device if the sound device is a translator, where the angle adjustment element 2 is clamped to the connection piece 12 with the clamping portion 22; the combination includes but is not limited to C-ring gripping, ring-like set, bump-fit, etc, the position limiting portion 121 is used to avoid the vertical sliding of the clamping portion 22, and the antiskid portion 221 is used to fix the combination position of the clamping portion 22 with the connection piece 12. Furthermore, one side of the hard fixation portion 21 is formed with the short slot type positioning portion 211 adapted to support and fix the outer edge of the earplug seat 11.

A user, upon implementation, uses a hand to hold the sound device 1 to place the earplug 11 into the ear canal first and the flexible support element 3 on one side of the inner ear otic bone, and then adjusts the tortuosity of the flexible support element 3 by matching it to the use's inner ear bone contours through the deformability of the flexible support element 3; it shout be emphasized that the flexible support element 3 has excellent deformability because it has a half moon, honeycomb and other frame-shaped hollow section 32 therein. After temporary positioning, the user may turn the sound device 1 with the angle adjustment element 2, allowing the flexible support element 3 to be rotated relatively so that the user can adjust more conveniently the flexible support element 3 to attach to the inner ear otic bone at a proper position so as to increase the fixation comfort thereof to the inner ear. Furthermore, the hard fixation portion 21 is used to stabilize the relative position of the sound device 1 to the flexible support element 3, thereby preventing the sound device 1 from being released when the user is in motion.

In addition, the flexible support element 3 can be adaptable to change, but individual differences between people always lead to the size problems of the flexible support element 3, the proper fixation cannot be done even if no matter how it is adjusted. To this end, the present invention uses C-shaped clamping portion 33 to fix to the sound device 1 to achieve convenient disassembly and assembly. Furthermore, the hard fixation portion 21 is fixed from inside and outside simultaneously, and the bonding strength and the ease of disassembly and assembly are taken into consideration because the flexible support element 3 is not only fixed to the hard fixation portion 21 by engaging the engagement portion 31 with the buckling portion 23 but by using the position limiting rib 311 to be inserted in the engagement slot 231. With the friction force of the material of the flexible support element 3 itself, the hard fixation portion 31 can be fixed from inside and outside, and both bonding strength and disassembly, assembly convenience can be taken into consideration. Therefore, only provision of users with different sizes of flexible support elements 3 can solve the problems mentioned above.

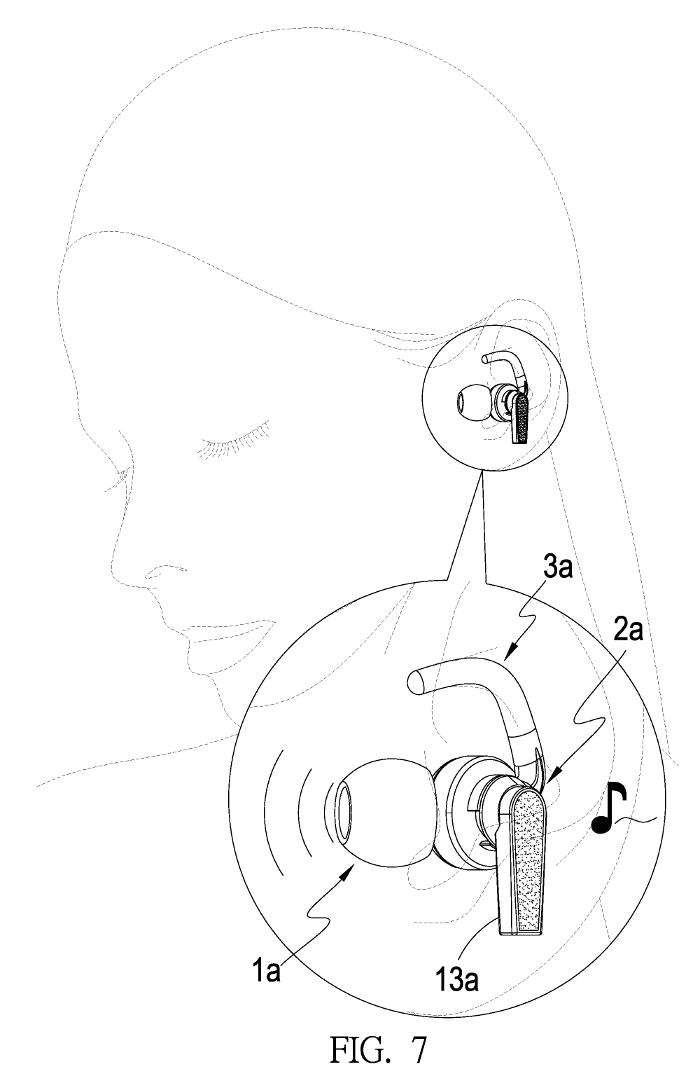

Furthermore, referring to FIG. 7, which is another preferred embodiment of the present invention, this embodiment is similar to the embodiment mentioned above, the only difference between them is that the sound device 1a is changed to a hearing aid in this embodiment, so the electronic device 13a is a radio and loudspeaker device (may also be a instant translator or other electro-acoustic product), so that the angle adjustment element 2a and flexible support element 3a can be similarly used to achieve the fixing effect of both hard and soft tactics.

I claim:

1. An electro-acoustic product stabilizing device, comprising:
a sound device;
an angle adjustment element, coupled pivotally to one side of said sound device, and adapted to adjust an angle of said sound device;
a hard fixation portion, configured on one side of said angle adjustment element; and
a flexible support element, in connection with said angle adjustment element and configured on one side thereof away from said sound device, and capable of being adapted to a user's ear cartilage contours and deformed freely to perform fixation.

2. The stabilizing device according to claim 1, wherein said sound device comprises an earplug seat, a connection piece configured on one side of said earplug seat, and an electronic device configured on one side of said connection piece far away from said earplug seat.

3. The stabilizing device according to claim 2, wherein said angle adjustment element comprises a clamping portion clamped detachably to said connection piece.

4. The stabilizing device according to claim 3, wherein said connection piece comprises a position limiting portion for preventing said clamping portion from sliding.

5. The stabilizing device according to claim 3, wherein at least one antiskid portion is configured on an inner side of said clamping portion.

6. The stabilizing device according to claim 1, wherein an inside of said flexible support element has at least one hollow section adapted to increase the deformation capability of said flexible support element.

7. The stabilizing device according to claim 2, wherein a positioning portion is formed on one side of said hard fixation portion, said positioning portion is adapted to fix an outer edge of said earplug seat.

8. The stabilizing device according to claim 1, wherein one end of said hard fixation portion is formed with at least one buckling portion, and on end of said flexible support element is formed with at least one engagement portion correspondingly coupled to said buckling portion.

9. The stabilizing device according to claim 8, wherein said buckling portion comprises an engagement slot, and said engagement portion comprises at least one position limiting rib inserted in said engagement slot.

10. The stabilizing device according to claim 1, wherein said sound device is a headset, hearing aid or instant translator.
